(19) United States
(12) Patent Application Publication
(10) Pub. No.: US 2008/0296258 A1
(43) Pub. Date: Dec. 4, 2008

(54) Plenum reactor system

(76) Inventors: David J. Elliott, Wayland, MA (US); Ronald P. Millman, Taunton, MA (US); Murray Tardif, Dunstable, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/703,996

(22) Filed: Feb. 8, 2007

(51) Int. Cl. C23F 1/00; B01J 19/12; B08B 7/00; B05D 7/00

(52) U.S. Cl. 216/66; 204/157.15; 427/595; 134/1; 422/129

(57) ABSTRACT

Techniques for generating reactions on surfaces that can operate at room temperature and pressure with visible laser light as a radiation source and environmentally sound gases for processing. The apparatus is highly compact, simple, reliable and low cost to operate and maintain, and can dry clean and condition surfaces without causing damage or leaving a residue. Gas is injected at one end of a plenum, directed through the plenum in the presence of the laser radiation, and exhausted at the other end. The plenum creates a highly confined space for directional laminar movement of gas, laser light and by-products, permitting a high degree of uniformity and reaction efficiency. Minimal internal surface area and volume of the reactor prevents by-products from forming, eliminating costly cleaning and downtime.

### FIELD OF THE INVENTION

The present invention relates generally to an apparatus and method for the treatment of surfaces in a gas phase environment. The present invention provides a novel method and apparatus for processing substrates with laser light and gas at room temperature and ambient pressure, eliminating heaters and complex vacuum pumps, hardware and overhead time associated with pulling deep vacuums. One use is as a cost effective method and apparatus for dry cleaning and conditioning of damage sensitive surfaces, such as for advanced semiconductor wafer processes. It finds particular application for the damage-less and residue-free cleaning and conditioning of delicate surfaces used in the fabrication of semiconductor and optical devices including integrated circuits, thin film heads, optical disks, and flat panel displays.

### BACKGROUND OF THE INVENTION

In general, the manufacturing of integrated circuits, thin film heads, optical discs and related substrates involves the use of thin, damage-sensitive surfaces, and a vacuum chamber. Prior art chambers for processing wafers are large and complex. They typically have large internal surface area and volume that makes them expensive to operate and maintain. The large internal volume requires considerable gas consumption in production of devices. The cost of the gas, and the cost to abate the effluent is timely and expensive. Further, the interior walls, having large surface area, cause problems when by-products falling back onto the wafers during processing, causing reject chips.

The accumulation of polymer films, corrosion and particulates on the interior chamber surfaces creates the need for frequent shutdown of the system for cleaning and/or replacement of corroded parts. For example, standard chambers used to manufacture integrated circuits are cleaned with nitrogen tri-fluoride (NF₃), a highly toxic and expensive gas that is particularly effective in removing polymer buildup on the interior walls of chambers. The lost production time from chamber cleaning and high gas cost associated with cleaning is a major concern to Integrated Circuit (IC) manufactures.

In addition to the problems with large surface-area chambers that require complex vacuum equipment, the process of cleaning itself is complex and costly. Conventional surface cleaning and resist removal in semiconductor manufacturing involves the use of strong aqueous chemicals such as sulfuric acid and ammonium hydroxide as well as organic solvents and large volumes of highly purified water. These corrosive and toxic chemicals require costly waste treatment, extensive facility infrastructure and complex and costly process equipment. These chemical processes also damage the semiconductor surfaces, and because of the necessity for multiple process steps in different and separate pieces of equipment, expose the semiconductor surfaces to additional contamination. The wet process equipment is very large and complex, requiring extra operators to run and maintain, and facility space and resources to support.

Many ‘dry’ alternative processes have been tried as a replacement for the more conventional ‘wet’ methods. One dry method uses reactive plasmas wherein a wafer is inserted in a chamber in the presence of a reactive gas that is excited by a high voltage field that produces reactive ions. This type of plasma will remove films of photoresist, but is known to cause surface electrical and physical damage to wafer films.

Another dry process, called “downstream microwave plasma ashing”, is also used to remove resist films. This process typically causes the problem of using high temperatures and leaves a residual carbon-based ‘ash’ behind, requiring extensive, additional wet cleaning steps. A particular problem with RF and microwave-based plasmas is the generation of hot fragments of resist above the wafer which fall back onto the coating and then cannot be removed except by strong aqueous chemicals, as they are partially carbonized.

Yet another dry process for resist removal is based on photo-activated gas. Photo-activated gas methods involve both static and flowing gas with short wavelength ultravioet (UV) radiation that is highly absorbed by the gas so as to generate excited species. While the excited species remove the resist, they also contain ions and radicals that damage the wafer surface. The short wavelengths needed to create gas absorption and excitation also have high electron volt (eV) energy-per-photon, which will physically roughen the wafer surface by heating and expansion of the surface.

Some dry resist removal methods use photochemical activation of a halogen gas such as fluorine or chlorine. These gases are corrosive to chambers, are toxic, and are very expensive. Further, they will etch and damage a semiconductor wafer, especially thin gate oxides and low-k dielectrics needed to fabricate next generation IC devices.

Prior art photon-based dry methods using short wavelength ultraviolet light have the problem of optical absorption of the optics in the beam path, including the chamber window, and need to use expensive and easily damaged UV transmitting beam forming optics and a sapphire, or calcium fluoride or high purity quartz window. The excessive scattering of short UV wavelengths of the prior art result in highly inefficient (six times the energy losses of the present invention) laser transmission system. As a result, prior art system required very large expensive laser sources.

Chambers of the prior art also create non-uniformities of gas distribution and flow, causing non-uniform reactions on the surface. This is due to a very large internal volume into which gas flows and creates many ‘eddies’ and areas on non-uniform flow. Film thickness control on advanced IC devices is specified to a few angstroms on, for example, a gate oxide of an IC device. Variations in gas distribution in an etch, deposition or cleaning chamber will create several angstroms thickness variation on the surface or in a film, causing reject devices. There is a need for a reaction chamber that eliminates the problems of various flow patterns inside a large chamber volume and the subsequent differences in the reaction rates that occur on the surface of the substrate.

All of the methods discussed above have the disadvantage of requiring chambers with large internal surface volume where reaction by-products are deposited. Also, prior art dry cleaning methods rely on short UV wavelengths (typically less than 250 nm) that cause gas excitation by absorption of light into the gas, resulting in high-energy species that damage the substrate. A further disadvantage is that prior art methods leave unacceptable residues of carbon-like material that can only be removed with complex chemical processes and equipment such as large wet benches. The added processing steps and equipment add both cost and complexity to the manufacturing process, and create added handling defects.

Also, prior art processes may require high temperatures in excess of 100 degrees centigrade that disturb the implant depths of semiconductor devices and reduce yields.

### SUMMARY OF THE INVENTION

It is therefore an object of the present invention to provide a reactor apparatus and method for dry cleaning and film removal from surfaces that overcomes the limitations of the prior art.

The above invention was made in light of the above needs and problems, and is directed to an apparatus and method for laser exposure into a plenum reactor with flowing gas. Accordingly, it is an exemplified feature of the present invention to provide a plenum reactor vessel that is simple in design, extremely low in internal volume, compact in size, reliable in operation, and with a low cost of ownership.

It is a further feature of the present invention to provide a plenum reactor that can operate at room temperature, ambient pressure, and use visible laser radiation. Room temperature operation eliminates the need for heaters, and eliminates the thermal damage caused by prior art processes. Ambient pressure operation eliminates the costly and complex vacuum pumps and plumbing, and significantly increases throughput or productivity by eliminating long pump down and recovery cycles. Visible laser radiation, with a photon energy range of ˜1.8-3.4 eV, will not roughen silicon, compared to prior art uv lasers in the 250 nm (5 eV) down to 157 nm (7.43 eV), known to create surface damage and roughening. In a particular embodiment, the plenum reactor will condition and clean surfaces at room temperature, room pressure, using visible laser radiation. The visible radiation may be accompanied by radiation from another wavelength to create a more efficient reaction, and the % contribution of each wavelength may be varied to produce an optimum reaction. The solid-state laser used will produce laser wavelengths from 266 nm to 1054 nm, basically a YAG diode pumped solid state laser.

It is a further feature of the present invention to provide a plenum reactor that is integrated with a laser radiation source for exposing surfaces inside the reactor through a window in the reactor.

It is still another feature of the present invention to provide a highly restrictive volume for light and gas interactions whereby minimal gas is used, and by-products from the reactions on the substrate surface are rapidly and efficiently removed so as to not deposit by-products onto the walls of the reactor or re-deposit particles onto the substrate.

It is still another feature of the invention to provide a reactor provide sufficient gas flow and pressure, using intake and exhaust nozzles with dedicated plenums, to operate without the use of vacuum pumps or heaters, and provide highly uniform surface reactions.

It is still a further feature of the invention to provide a method using only oxygen and ozone gas with near-visible to visible laser radiation to perform organic cleaning processes that do not require waste treatment, use toxic chemicals, or present safety hazards. Finally, it is a feature of the invention to provide relatively high productivity measured in substrates per hour.

In the present invention, in order to achieve such features, the plenum reactor has a highly simplified design, with only one moving part, providing high reliability. The portion of the plenum reactor is which the substrate is held and processes is designed for minimal volume, and is significantly smaller than prior art semiconductor wafer process chambers. This tiny vessel is extremely simple, low cost, and requires a fraction of the gas to process wafers, and a fraction of the time since the plenum reactor can operate at room pressure, without any vacuum pump down time or pump. The tiny volume of the process vessel of the plenum reactor eliminates the problem of chamber wall contamination and chamber cleaning, a costly and time-consuming maintenance procedure. The streamlined shape of the process vessel also eliminates the non-uniform gas eddies that occur in prior art chambers that lead to non-uniform reaction rates. The plenum reactor provides highly uniform gas flow and uniform reactions. The flow of gas through the tiny volume of the plenum reactor vessel results in, for example, rapid photoresist removal times of 60 seconds for a 200 mm wafer with a film thickness of 1.0 um. This time is roughly three to six times faster than prior art tools. Productivity is a major feature in reducing manufacturing cost in IC fabrication facilities.

According to one aspect, the gas is fed into a plenum connected to a multi-port gas injection nozzle, which in turn feeds gas into the vessel where if flows across the substrate. Only a small amount of gas is needed to produce the reaction on the surface of the substrate, and at the other end an exhaust nozzle, coupled to a second plenum, withdraws the by-products. The light source is a compact, solid-state laser that is highly reliable, and uses near-visible laser radiation. Prior art cleaning systems use large, ultraviolet lasers that require fluorine gas and extensive maintenance. The plenum reactor system permits a highly efficient, rapid process for reacting materials on surfaces, and withdrawing by-products as they are generated, leaving behind a pristine, clean substrate.

According to one aspect, the invention is directed to a plenum reactor system. The system includes a laser source for generating a beam of radiation. A scan head directs the beam through a window in the plenum reactor vessel and onto the substrate.

In one embodiment, the plenum reactor system further includes an input plenum integrated with a gas injection nozzle bank to provide gas flow through the plenum reactor.

In one embodiment, the input plenum has a series of baffles to equalize the gas pressure at the face of the nozzle bank. In one embodiment, the input and exhaust plenum and their respective nozzle banks are integrated as a single piece.

In one embodiment the bottom base of the plenum reactor vessel has a pocket with a tapered sidewall to accept a round substrate. The tapered walls of this machined pocket permit self-centering of the substrate.

In one embodiment, the plenum reactor vessel includes a window between the scan head and the substrate. The window is the top cover of the plenum reactor vessel.

In one embodiment the laser source beam is directed through a beam homogenizer to provide uniform illumination at the substrate plane.

In one embodiment, the window has a curved surface to act as a lens and thereby change the incident angle of the light at the substrate plane, thereby equalizing the angle at which the light beam is deposited at all points on the substrate. The window can include borosilicate glass, quartz, or calcium fluoride.

In one embodiment, the laser source comprises a solid-state laser. In one embodiment the laser is a diode pumped laser. In one embodiment, the laser source comprises a YAG laser.

In one embodiment, the laser source comprises a laser operating in a wavelength range of 251 nm-1070 nm.

### BRIEF DESCRIPTION OF THE DRAWINGS

The foregoing and other objects, features and advantages of the invention will be apparent from the following, more particular description of preferred embodiments of the invention as illustrated in the accompanying drawings, in which like reference characters refer to the same parts throughout the different views. The drawings are not necessarily to scale, emphasis instead being placed upon illustrating the principles of the invention.

FIG. 1 is a schematic view of a plenum reactor system in accordance with one embodiment of the invention.

FIG. 2 is a top view of the plenum reactor system in accordance with one embodiment of the invention.

FIG. 3 is an orthogonal view of the nozzle bank in accordance with one embodiment of the invention.

### DETAILED DESCRIPTION OF THE INVENTION

A description of example embodiments of the invention follows.

In a preferred embodiment, the plenum reactor system of the present invention is designed to rapidly and efficiently clean or condition a substrate by using a highly confined internal volume in which an optimized gas flow and laser radiation produce reactions. The small internal volume uses a minimal amount of gas, and the linear gas flow in a confined space permits reaction by-products from the laser and gas reactions to be evacuated as they are produced, and not deposit back onto the wafer or on the walls of the reactor.

The plenum reactor system can operate at room temperature and at atmospheric pressure, eliminating costly vacuum pumps and associated hardware and long pump cycles. The plenum reactor system is also very compact, partly because it uses a small solid-state laser, and also because the chamber is only slightly larger than the substrate. The plenum reactor system of the present invention thereby permits cost effective manufacturing and high throughput for processing semiconductor wafers in advanced IC manufacturing in a number of critical surface cleaning and conditioning applications.

In specific embodiments of the present invention, in order to achieve high reliability, a solid-state laser is used at a near-visible or visible wavelength, allowing much longer optics life and very small energy losses from the laser. The use of a long wavelength, such at wavelengths in the 266-650 nm range, compared to short ultraviolet wavelengths of the prior art which are in the range of 190-250 nm, permits a much smaller and higher reliability laser to be used. The long wavelengths of the present invention also have very low eV/photon range (1.8-3.4 eV) compared to the prior art (4.5-6.4 eV), eliminating the surface roughening on wafers caused by high energy-per-photons in the deep ultraviolet region.

In specific embodiments of the present invention, in order to perform in multiple applications, the scan head can be programmed to write any number of programs, so the system can be used for direct lithography or patterned exposures without the need for a photo-mask. The software programs may be selected, for example, for removing an edge bead of resist from a wafer, a common problem from spin coating that frequently requires the use of a dedicated ‘edge bead removal’ system.

In embodiments of the present invention, in order to prevent thermal damage to the substrate, the system can be operated at room temperature, and even below room temperature. It can also be used at elevated temperatures in the range of 25-100 C. For example, in one embodiment, thick organic residues were removed in an oxygen/ozone atmosphere in a temperature range of 5-15 C.

In another embodiment, a series of baffles creates a tortuous pathway for the gas from the input end, thereby allowing the pressure to equalize in the plenum, and more importantly, at the face of the input nozzle. The same configuration is used for the exhaust plenum and exhaust nozzle.

In yet another embodiment, the holes of the input and exhaust nozzles are threaded to create a spiral flow of gas, thereby increasing the velocity. In another embodiment, each of the multiple holes in the nozzle bank is filled with a ruby-throated brass nozzle with a specified orifice, each calibrated to produce a given flow and pressure condition inside the plenum reactor vessel.

In another embodiment, the scan head scans the laser beam across the surface of the substrate in one of many different patterns, depending on the application. The beam can be programmed to deposit laser pulses in a wide variety of configurations. For example, on a very damage sensitive surface, such as a low-K dielectric layer, the laser pulses can be deposited with wide spacing in a series of non-overlapping scan passes. This particular algorithm of pulse deposition eliminates the problems of laser radiation damage caused by adjacent pulses, where deposited heat from the pulses accumulates to crack the irradiated film of low-K oxide. Many advanced semiconductor processes require the use of ultra-thin films that are easily damaged by conventional surface treatment processes, especially cleaning.

The present invention can be implemented as a dry processing reactor apparatus and method, using laser light and gas. More specifically, the invention can use a scanning laser and flowing gas reactor system for surface cleaning and conditioning of surfaces encountered in advanced semiconductor manufacturing. In particular, the invention can be used for cleaning organic materials off a surface without damaging the surface or leaving any residue behind. The invention can also be applied to direct lithography, where the laser beam and gas in the plenum reactor vessel create solid images in a polymer material, eliminating the need for a photo-mask. The invention also uses laser light and gas to effect surface reactions including annealing, curing of polymer films, and oxidation of copper or other films.

In preferred embodiments, the invention features a compact reactor vessel with plenums, a small solid-state laser light source with homogenizing optics and a scan head. The entire plenum reactor system can fit easily onto the surface of a standard small desk, and can operate at room temperature and ambient pressure, using ‘green’ gases such as oxygen, ozone, ammonia, or hydrogen to create a wide variety of surface reactions.

In accordance with one aspect of an embodiment of the invention, there is provided a compact plenum reactor with a compact laser optical system including a solid state laser with pulse energies in the range of 0.1 um to 2.0 millijoules that do not generate significant heat in the bulk of the substrate as is the case with prior art laser cleaning systems. In a preferred embodiment of the invention, the laser pulses are distributed by a programmable scanning algorithm that distributes the heat energy to prevent damage the substrate, and provides rapid cycle times for high productivity.

In accordance with one aspect of the preferred embodiment, there is provided a laser optical and gas reactor system that is smaller, cheaper, and has higher optical and process throughput efficiency, and consumes less energy and footprint than prior art dry cleaning and optical imaging systems.

In accordance with one embodiment of the invention, the plenum reactor system is used to anneal thin films of PVD copper on silicon wafer surfaces. The wavelength of the beam at 355 nm when using a frequency tripled YAG laser will not create any significant heat in the bulk of the silicon wafer, but will melt the copper film on the surface.

In accordance with one aspect of a preferred embodiment, the window on the top of the plenum reactor vessel is made from low cost, high purity borosilicate glass. Since the laser light wavelength is not in the deep ultraviolet, expensive quartz is not required.

Several prior art laser and gas systems for cleaning and surface conditioning are based on the use of UVlight, and are limited because of the need for large and unreliable excimer or similar wattage and footprint laser sources, and the dependence on expensive and short lifetime uv optics because they are easily damaged by the high photo energy of uv photons in the wavelength range of 157 nm (7.43 eV) to 248 nm (5.00 eV). In a preferred embodiment, the laser of the present invention is instead a small footprint solid state laser with 355 nm, low energy (3.49 eV) photons.

At the 355 nm wavelength, energy efficiency, measured by the difference between laser output and substrate plane energy, is typically very high. For example, the laser outputs 12 Watts, and the energy at the substrate plane is ˜9 Watts; this compares to the prior art wavelength of 193 nm, wherein the output of the laser is 30 Watts, and the energy at the substrate plane is only 3 Watts. Thus, prior art methods require much larger lasers, and are several times less efficient than the near-visible laser of the present invention. Visible light lasers are even more efficient. This is because shorter wavelengths have higher losses from both optical absorption in the optics (lenses, not mirrors), and higher losses from surface scattering on all optical surfaces.

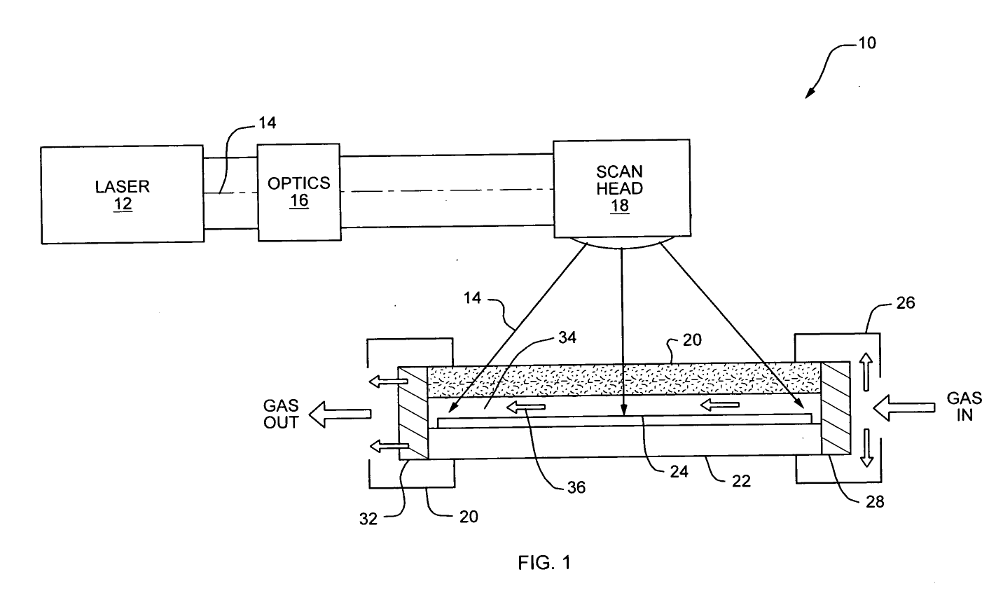

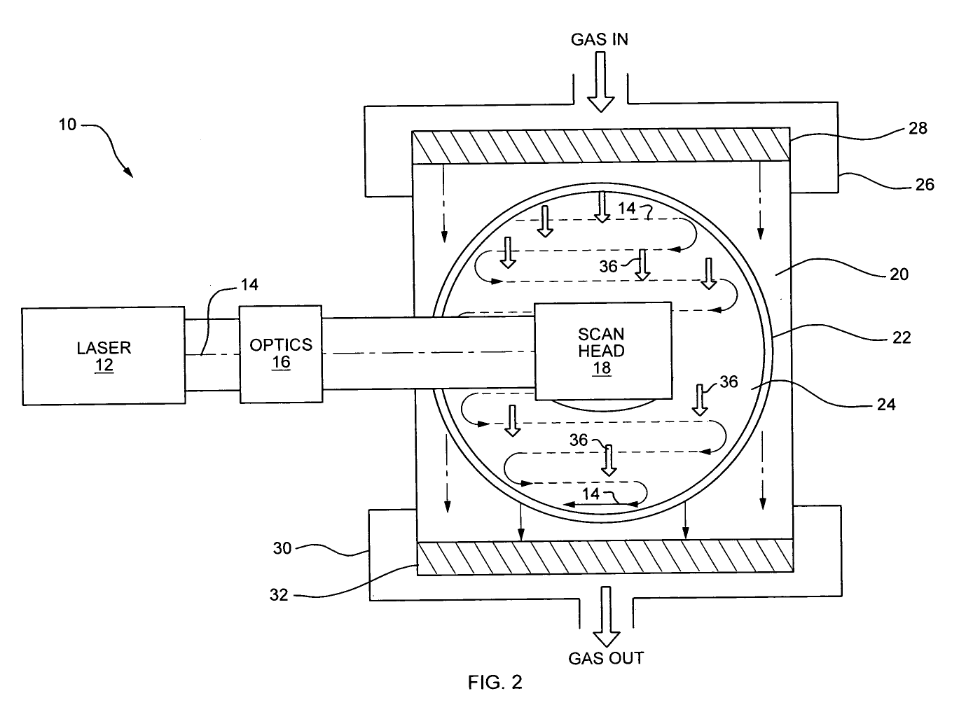

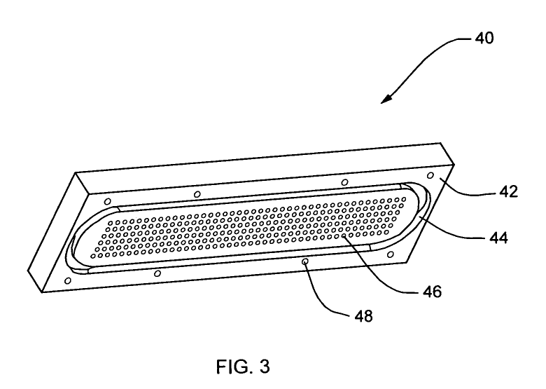

One example of a plenum reactor system embodying the invention will now be described with reference to the drawings. FIG. 1 is a schematic view of one embodiment of the plenum reactor system including a laser source and imaging optics, and FIG. 2 is a top view of one embodiment of the plenum reactor system, also including laser source and imaging optics. FIG. 3 is an orthogonal view of one embodiment of a nozzle bank used in the plenum reactor system.

Referring to FIG. 1 and FIG. 2, the plenum reactor system 10 includes radiation source 12, for example, a ten-watt solid state laser 12, that is capable of generating radiation in the range of 266-1065 nm in a beam 14. In a preferred embodiment, the beam 14 may contain more that a single wavelength. For example, 355 nm radiation and 532 nm radiation may be contained collinearly in the same beam. In another embodiment, wavelengths may be added to beam 14 before they reach substrate plane 24, or selectively filtered along the optical axis before reaching substrate plane 24. In another embodiment, multiple wavelengths can be used to increase or decrease the absorption of the gas flowing across the substrate in the plenum reactor. In yet another embodiment, multiple gas streams, each with particular absorption properties to match the laser output to produce a useful reaction, may be used. For example, ozone can be added to increase the absorption of laser radiation at a 266 nm wavelength in organic cleaning reactions, but the amount of ozone will be limited to ˜1-5% by volume to prevent extreme absorption and extinguishing of the entire beam.

The laser source 12 can be a diode pumped solid-state YAG laser or other similar laser. In one particular embodiment, the laser is a frequency-tripled YAG laser operating at a primary wavelength of 355 nm. The primary beam may also be a wavelength of 266nm, 532 nm or 1064 nm, with or without radiation of another wavelength.

The optical system also includes, disposed along axis 14, an optics module 16 which transforms a non-uniform beam of radiation into a more uniform beam shape, reducing the difference between the maximum energy density and the minimum energy density. The optics module is also used to expand or contract the beam size and shape. In one embodiment, the optics module 16 includes three cylinder lenses with theta adjustment to correct the beam shape, a variable expander to reduce energy density downstream and control beam divergence, and a beam flattener to reduce maximum-to-minimum intensity variations. In one embodiment, the variable expander includes three spherical lenses with a magnification range, for example, of 1.0-5.0x, and can be reversed for performing e-magnification in a range of, for example, 1-0.2x.

The beam is then directed along optical axis 14 into scan head optical sub-system assembly 18. The scan head optical sub-system assembly 18 can be model “hurrySCAN14”, provided by ScanLab AG, of Puchheim, Germany, or other similar device. In one embodiment, the scan head optical sub-system assembly 18 can contain a telecentric f-theta lens to provide a beam incident angle at the substrate 24 of less than 6 degrees. The function of scan head optical sub-system assembly 18 is to focus the beam, while passing through quartz chamber window 20, onto the substrate plane 24. In a preferred embodiment, the three modules 12, 16, and 18 in the optical path are designed with a minimum number of simple elements to maximum laser efficiency, permitting the use of a small solid-state laser that is highly reliable and cost effective, allowing use of the invention in production manufacturing applications.

Referring to FIG. 1, the space between quartz chamber window 20 and substrate surface 24 can be controlled with different ambients, pressures, and flows without the use of a vacuum chamber or other costly structure for the primary applications of cleaning, curing, oxidizing, annealing, and imaging. The space 36 between the plenum vessel window 20 and the bottom of the plenum vessel 22 may be as narrow as 5 mm to permit high velocity flow across substrate surface 24. The space 36 may also be increased to facilitate reactions wherein greater headroom is needed for reaction components including a low-level plasma reaction occurring above substrate surface 24.

Referring to FIG. 3 the gas injection and exhaust nozzle bank 40 is used to provide highly uniform laminar flow across the surface of substrate 24 to insure uniformity of the reaction occurring as substrate surface 24. Nozzle bank 40 is mounted, with screws going through mounting holes 42, so it is adjacent to both the input plenum 26 and exhaust plenum 30, the plenums delivering a pressure-equalized volume of gas. The body of nozzle bank 40 is further machined with an O-ring groove 44 so it can be sealed with an O-ring. The multiple openings 46 in nozzle bank 40 provide considerable mixing of the gas as it flows across the substrate surface, producing highly uniform reactions.

In cleaning applications, the reaction of the laser 14 and flowing gas 36 with surface contamination on substrate 24 moves in a singular direction through the plenum and out through exhaust nozzle 32 into exhaust plenum 30. Reaction by-products are carried toward the exhaust end of the reactor as they are generated. This ensures that the cleaned portions of the substrate are not subjected to re-deposition as in prior art reaction chambers that generally have unidirectional flow and 360 degree exhaust pulled by vacuum pumps. The directional force of gas flow through the confined space 34 of the plenum reactor keeps fresh reactant gas at the edge of the cleaning margin.

As shown in FIG. 2, the beam scans from one end of the substrate in a particular embodiment, to the other end of the substrate in the same direction as the gas flow. Cleaning progresses as with a broom, moving by-products toward the exhaust, preventing them from re-contaminating the substrate or underside of chamber window 20. The gap 34 in which the cleaning reaction occurs can be, in a particular embodiment, as narrow as 4-5 mm, so only a small amount of gas is required to clean substrates, making the process highly cost effective, and also making the cleaning time very short as gas is concentrated in a tiny volume with precisely controlled conditions of pressure and temperature.

In curing applications, the laser beam 14 is directed across the substrate surface for the purpose of photo-chemically changing, de-solvating, or re-arranging the molecular structure of a polymer or other film. The role of the gas in these applications can vary from simple cooling the surface with helium while the laser radiation produces a photo-crosslinking, photo-soluable, or photo-rearrangement reaction in the film on the substrate surface. The photo-curing of films is used to produce stable low K layers, in a particular embodiment.

In oxidizing applications, a regulated flow of 4-10 standard liters per minute of gas such as oxygen and ozone in various ratios permits the growth of a highly uniform oxide on PVD copper films used as interconnect metal films on advanced integrated circuit devices. The thickness of the oxide can be controlled precisely by the dose of the laser radiation used while the gas 36 flows through the plenum reactor 10, across the substrate surface 24. In a particular embodiment, the oxygen is mixed with 15% by volume ozone and the beam is a 355 nm wavelength solid state laser operated in the 10-30 KHz reprate range with a scan speed of 500-2000 meters per second and a pulse energy in the range of 0.5-2.0 mJ per pulse.

The substrate temperature can be at ambient, but in another embodiment, a thin flexible heater can be added to the plenum ‘floor’ 22 to accelerate the oxidation process. When run without any heat, the process time to grow the oxide is in the range of 3 to 10 minutes per wafer. The process time can be shortened by using higher concentrations of ozone in the oxygen-ozone gas mixture. The plenum pressure can vary from just above ambient to seven atmospheres. This process is used, for example, on 200 mm and 300 mm diameter silicon wafers.

In annealing applications, wavelengths in the 355 nm to 532 nm region can be used to flow thin copper layers to seal pores in the metal, or to re-flow the copper to relieve stresses left from deposition or for other structural reasons. The gas used for this applications can be helium or other inert gas flow.

In imaging applications, the choice of wavelength will be determined by the spectral absorption properties of the material being exposed. Thus, a wide range of wavelengths of laser radiation may be needed to expose the variety of photoresists available.

In a particular embodiment for highly cost sensitive applications, a 532 nm green solid state laser is used as the radiation source, and the gas is either nitrogen, air or oxygen, used at low flow rates and used with slight positive pressure and ambient temperature. Visible laser radiation permits the use of a lower cost chamber window, made with borosilicate glass instead of quartz. At 532 nm wavelengths, the cost of the laser, watt for watt, is half as much as the exact same solid-state laser at 266 nm. Visible light, such as 532 nm ‘green’ laser radiation, is highly useful for driving many types of reactions, including oxidizing reactions to remove photoresist films, annealing, curing and imaging.

The photon energy of 532 nm radiation is also much lower that at shorter wavelengths, permitting much higher damage latitude.

The substrate sits on a substrate holder 22, and is further enclosed by attachment to injection nozzle 28 and exhaust nozzle 32, as well as intake g as plenum 26 and exhaust gas plenum 30, leaving the gap 34 for the interaction of beam 14, gas flow 36 with substrate surface 24 inside the plenum reactor.

While the present invention has been particularly shown and described with reference to exemplary embodiments thereof, it will be understood by those of ordinary skill in the art that various changes in form and details may be made therein without departing from the spirit and scope of the present invention as defined solely by the following claims.

What is claimed is:

1. A method comprising:
inserting a substrate into a plenum vessel; the plenum defining a confined space about the substrate;
coupling a gas source to the plenum, thereby causing gas to flow over a surface of the substrate within the confined space; and
coupling a light source to the plenum, thereby causing reactance between the gas, the light and the substrate.

2. A method as in claim 1 wherein the gas flow is a laminar gas flow.

3. A method as in claim 1 wherein the gas flow is a uni-directional gas flow.

4. A method as in claim 1 wherein the gas is selected to cause ozonlysis of the substrate.

5. A method as in claim 1 wherein the gas is selected to cause a reducing reaction with the substrate.

6. A method as in claim 1 wherein the gas is selected to cause an oxidizing reaction with the substrate.

7. A method as in claim 1 wherein the gas is selected to cause a cooling reaction with the substrate.

8. A method as in claim 1 wherein the light is of a range from near-visible to a visible wavelength.

9. A method as in claim 1 wherein the light is visible light.

10. A method as in claim 1 wherein the gas and wavelength of the light source are selected to cause a dry reactance of the gas with the substrate.

11. A method as in claim 1 wherein coupling the light source further comprises: scanning the light source over a surface of the substrate.

12. A method as in claim 11 additionally comprising holding the substrate stationery within the plenum during the scanning of the light.

13. A method as in claim 1 wherein the gas is coupled to the plenum near the substrate.

14. A method as in claim 1 additionally comprising withdrawing the gas from the plenum near the surface of the substrate.

15. A method as in claim 1 wherein the reactance provides one of cleaning, micromachining, annealing, marking, oxidizing, etching, depositing, curing or drying the substrate.

16. A method as in claim 1 wherein the plenum in maintained as an ambient temperature.

17. A method as in claim 1 wherein the plenum is maintained at slightly above ambient pressure.

18. A reactor for treating the surface of a substrate comprising:
a plenum into which a gas may be introduced;
a plenum-like vessel for containing a substrate, the vessel having a window to allow laser radiation to enter therein;
a gas inlet, arranged to distribute a flowing gas across a surface of the substrate, and to thereby cause a reaction;
a gas outlet, located
at an opposite end of the plenum-like vessel from the inlet, for exhausting gas and by-products as they are generated across the substrate-containing vessel.

19. An apparatus as in claim 18 wherein the laser beam and flowing gas are made to cover the entire substrate surface.

20. An apparatus as in claim 18, wherein the vessel is at atmospheric pressure, the laser radiation is visible light spectrum light, and temperature within the vessel is an ambient temperature
